(19) United States
(12) Patent Application Publication
(10) Pub. No.: US 2007/0158409 A1
(43) Pub. Date: Jul. 12, 2007

(54) Process for validating identification badges and heat transfer ribbon therefor

(76) Inventor: David J. Haas, Suffern, NY (US)

Correspondence Address: Michael E. Zall, Two Yorkshire Drive, Suffern, NY, 10901, US

(21) Appl. No.: 11/315,112

(22) Filed: Dec. 23, 2005

(51) Int. Cl. G06K 5/00

(52) U.S. Cl. 235/380

(57) ABSTRACT

A process for validating an identification badge for a plurality of predetermined periods of time. The process includes generating, preferably randomly, an initial image for an initial predetermined period of time and then transmitting this initial image to a heat transfer printing device. The heat transfer device prints the image on the identification badge to thereby validate the badge for the initial predetermined period of time. Subsequently, a subsequent image is randomly generated for a subsequent predetermined period of time. This subsequent image is then transmitted to the heat transfer printing device. The device subsequently prints the subsequent image on the identification badge to overlay the initial image, thereby concealing such initial image and validating the badge for the subsequent predetermined period of time. A novel heat transfer ribbon is also provided.

### BACKGROUND OF THE INVENTION

1. Field of the Invention

The present invention relates to a process for validating identification badges and passes for a predetermined period of time. In particular, this invention provides a clearly visible printed image, text or symbol, on employee identification cards (badges) for daily coding of each persons badge. In particular an image-code printing device produces a label-like sticker for temporary visual coding of any identification badge. The invention further relates to a means for making and applying a label-like sticker that can be printed with an image, date, or coding so that it can be attached in a nonpermanent manner, without special material requirements, to any flat item or surface such as an identification badge. The label-like sticker is secure, tamper evident, tamper resistant and non-transferable. The present invention also relates to a novel heat transfer ribbon for use in the process.

2. Related Art

For the past several years, the development of image coding systems has been stalled due to the difficulties encountered in applying the image code onto the various types of identification badges. Any useful and secure coding system for identification badges must be capable of applying a large coding image that can be clearly displayed on the identification badge. Generally, it is impractical to apply an adhesive label to each badge, every day as a new image code is generated for that day. One system that is used employs rewritable films manufactured by Ricoh and Mitsubishi Paper Mills of Japan. These rewritable films are constructed as part of the original badge or the rewritable film is added to the badge by applying it to the front surface as a pressure sensitive film. The image is printed on the film by a thermal printing process by applying heat in a first heat-pass to erase the previous image code and then a second heat-pass to print a new image code. Although this system is practical, it is very complicated and expensive to modify all the employee badges at a facility. Additionally, such rewritable films can only perform for about 500 heating cycles before they must be replaced.

Given the present state of the art, the general procedure is to change employee identification badges once a year. However, this still means that an unauthorized person could use a visually valid badge for, say a year, until it is replaced. An ideal security system would provide identification badges that are validated continuously, e.g., every minute. However, given the present state of the art, validating each identification badge every day is more practical. Such daily validation provides a substantial enhancement to the security of a facility.

Such a daily validation system requires a randomly generated image code associated with a specific date of use. Generally, generation of such a random code is known in the art and can be readily accomplished through known hardware and software. The major obstacle in instituting, for example, a daily validation system, is in printing the image code and/or associated date on all the different identification badge types used at a facility or group of facilities and organizing the logistics of having all the employees or authorized visitors' pass through the validating stations at various times during the day. This is further complicated by the fact that such visitors or employees can enter and leave at various times through various entrances and exits. This is still additionally complicated by the fact that the employees and visitors carry their identification badges in various type holders and by various means.

Thus, image code printing on badges has been a major barrier to the successful implementation of a practical and commercially viable image coding system. As can be readily seen, the daily application of adhesive labels to identification badges is impractical because the labels accumulate on the badges, leave an adhesive residue on the badges, and can be peeled off and reapplied to an invalid identification badge.

As indicated, the only present practical solution found to date has been to employ rewritable thermal films. However, it is cumbersome and complex to add these thermal films to each and every identification badge, the films have a limited number of prints before the film must be replaced, and the complexity of printing on such films, makes such a system impractical for large-scale applications. Additionally, the label and material costs as well as the labor involved makes the use such rewritable films impractical.

### OBJECTS AND SUMMARY OF THE INVENTION

It is an object of this invention to provide a substantially universal process for applying coding images to any type or brand identification badge.

It is a further object of this invention to provide an image coding security system wherein each employee at a facility can readily determine if an identification badge that they observe is authentic and valid for a predetermined period of time, e.g., that day.

It is another object of this invention to provide a system of coding identification badges that offers substantial assurances for every employee that all the people in the facility are authorized to be there.

It is another object of this invention to provide a system that prevents people from using unauthorized Identification badges, such as terminated employee badges, counterfeit badges, expired employee badges, and stolen employee badges that may initially appear valid.

All of the foregoing objects of this invention and others are achieved by a process for validating an identification badge for a plurality of predetermined periods of time. The process comprises:

generating, preferably randomly, an initial image for an initial predetermined period of time;

transmitting the initial image to a heat transfer printing device;

heat transfer printing the initial image, preferably as an opaque transfer layer, onto the identification badge to thereby validate the badge for the initial predetermined period of time;

generating a subsequent image for a subsequent predetermined period of time;

transmitting the subsequent image to the heat transfer printing device;

heat transfer printing the subsequent image, preferably as an opaque transfer layer, onto the identification badge to overlay the initial image to thereby conceal such initial image and to thereby validate the badge for the subsequent predetermined period of time.

### BRIEF DESCRIPTION OF THE DRAWINGS

Other important objects and features of the invention will be apparent from the following Detailed Description of the Invention taken in connection with the accompanying drawings in which:

FIG. 1 is a cross section of a heat transfer ribbon used in the process of this invention.

FIG. 2 is a perspective view of an identification badge that has been validated by the process of this invention.

FIG. 3 is a schematic view of the printing system used in the process of this invention.

FIG. 4 is a cross-sectional view of an identification badge that has had a plurality of validations.

FIGS. 5A and 5B are schematic views of the printing station and ribbon used in the printing system for this invention.

FIG. 6 is a schematic view of another embodiment of the printing station used in the printing system for this invention.

FIG. 7 is a cross section of another type heat transfer ribbon used in the process of this invention.

### DETAILED DESCRIPTION OF THE INVENTION

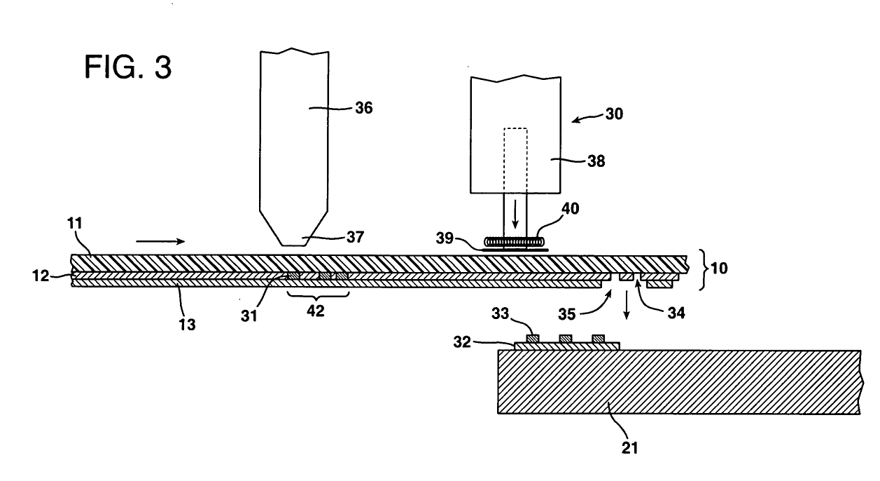

Referring to the Figures, this invention includes as an aspect thereof the use of a thermal printer 30, as shown FIG. 3, which does not print directly onto the identification card surface, but transfers an image from the ribbon 10 to the identification card 21 surface by application of an opaque transfer layer 22 thereto. Preferably the transfer layer 22 is not a rigid substrate but is a substrate that is non-cohesive such that when removed from the identification badge 21 it crumbles and disintegrates making it impossible to transfer to another badge and when so removed leaves a tamper evident residue.

There are numerous specific image transfer systems and apparatus that can be used in this invention. For example, a first system employs a heat-activated adhesive transfer means. A second system employs a pressure-sensitive adhesive transfer means.

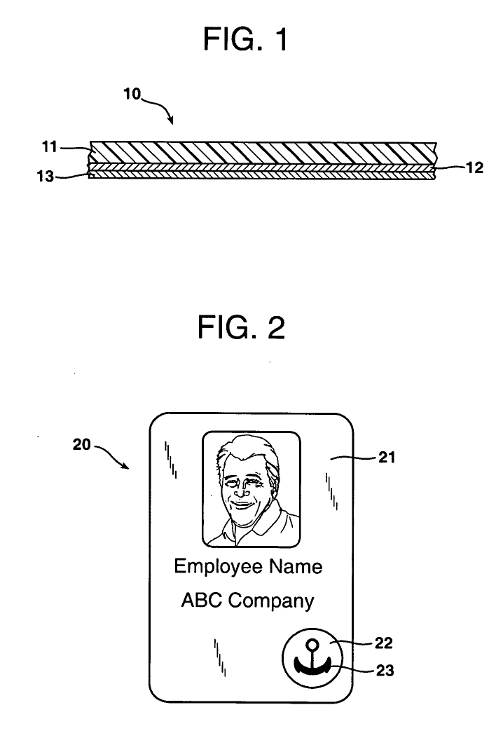

Referring to FIG. 1, a thermal transfer ribbon 10 is provided having two layers 12, 13 coated onto a carrier substrate 11. The carrier 11 is typically 0.2 to 0.5-mil polyester. Layer 12 is the image forming layer while layer 13 is an opaque transfer layer used to cover the previous image remaining on the identification badge 21. Layer 13 is typically white, but it can be any color that makes it opaque, and it can also contain security modalities such as holographic images or reflective flakes.

Referring to FIGS. 1 and 3, the function of the ribbon 10 is two-fold. Firstly, it creates the image when the ribbon 10 passes under the thermal printing head 36. Secondly, the image forming layer 13 acts as the base support for the image created in layer 12 and obliterates, covers-up or hides the previous image code 33.

The mechanism by which the image is created depends on the specific thermal transfer ribbon construction. Layer 12 can be a colored ink which operates like standard thermal transfer ribbon. When the colored ink in layer 12 is heated, it melts and bonds to the opaque, e.g., white, base layer 13, so that when the base layer 13 is transferred to the plastic card 21, the base layer only carries the colored ink image with it, leaving the remainder of the colored ink, which was not heated, on the ribbon substrate 11. The heating temperature to melt the colored ink 12 is much higher than that of the heating temperature required to transfer the base layer 13 to the identification card 21, which is typically a plastic. Otherwise, all the colored ink 12 would be transferred with the base layer 13 when it is transferred.

In a second embodiment, layer 12 is a clear coating of thermal chemicals. Thus, when the ribbon 10 is heated by the thermal print head 36 only that portion of the thermal chemical directly affected by the heating elements 37 change colors, leaving the remainder of the thermal chemicals on the ribbon 10 in their original state, e.g., a clear layer. Thus when the base layer (13 in FIGS. 1 and 32 in FIG. 3) is transferred to the badge 21 surface, the entire direct thermal coating layer 12 can be transferred with it instead of just the printed portion of the layer. By transferring both layers 12 and 13 to the identification card 21 as shown in FIG. 3, less accuracy is required for controlling the separation of the various coated layers on the thermal transfer ribbon.

Referring to FIG. 2, as a result of this process, the plastic identification card 21 preferably receives a randomly generated colored image code 23 when it is authorized by the validating unit for that day. The colored image code 23 is applied to the plastic card 21 on a white base layer 22, which adhesively attaches to, for example, the plastic identification badge 21.

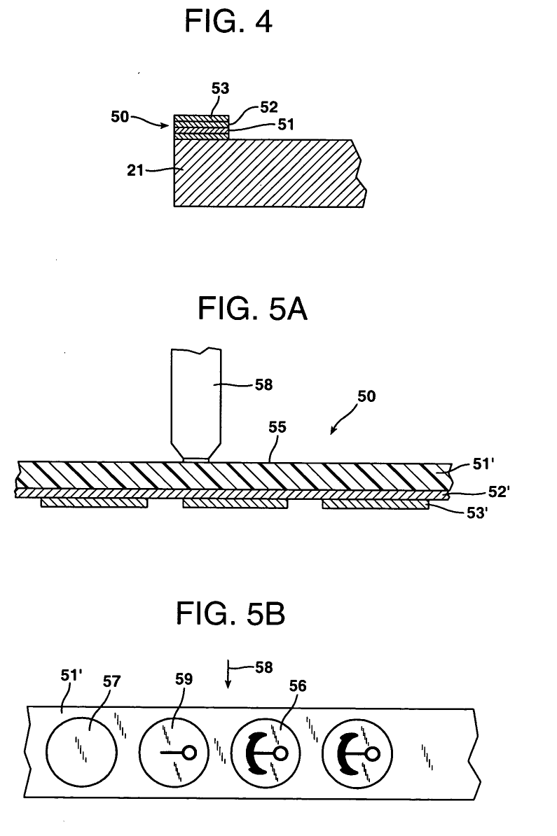

As shown in FIG. 4, the badge or card 21 may already have many image codes 51,52 thereon that have been applied on previous days. The white base layer 22 will hide image codes directly below it from another day, as are the previously applied base layers hiding the respective image codes below them. However, because none of these applied layers have a rigid substrate, the entire mass of layers of resin 51, 52, 53 attached to the plastic card or badge 21 are difficult to remove in an orderly fashion so that it will make transferring these security image codes to another card difficult, if not impossible. One of the primary benefits of this image code printing and transfer system is that the image code itself lacks a strong and cohesive support structure, thus making it more tamper resistant and when removed will leave tamper indicating evidence on the card or badge.

FIG. 3 depicts an example of one particular printing device for this image code coding system. In this device, ribbon 10 is transported through the printing device 30. The device consists of three parts: the thermal printing head 36, the image code transferring mechanism (solenoid) 38, and the identification card 21 which receives the image code. The ribbon 10 moves at a uniform speed and is in contact with the printing head 36. At the end of the head 36 is a linear array of individual heated printing elements 37 arranged to generate the image that has been transmitted to the head 36 and the pixel areas of the ribbon. If the colored component 12 of the ribbon 10 is a colored thermal ink, then the heat causes the colored ink to melt and bond to the white transfer coating 13 under it. If the component 12 is a direct thermal coating, then the heat causes the chemistry of the direct thermal coating to change color and remain bonded to the white transfer coating 13. In either case, the image code is created within the thermal transfer ribbon so that it can be transferred to the identification card 21 at the next station 38 of the printing unit.

This thermal transfer mechanism differs from conventional thermal transfer printing units in that in conventional thermal transfer printing the thermally created image is immediately and directly transferred to the receiving substrate, the printing process applying the melted colored ink directly to the receiving substrate. In this invention, the image is created within the ribbon before applying it to the substrate card.

Referring to FIG. 3, the printed image 42 is transported to the image transfer station 38 as the ribbon moves along it the path. A sensor detects this image and activates the solenoid 38 which presses the thermal transfer ribbon onto the identification card 21 which receives the image. A heater 40 on the transfer platen 39 melts the white base layer 13 to the extent that it separates from the contiguous coating and enables the white base layer to bond to the plastic surface of the identification card 21. Typically, the transfer platen 39 will be round so that alignment with the edges of the identification card 21 and underlying image codes is not critical. In particular, the transfer platen 39 is heated sufficiently to melt the white transfer layer, but not sufficiently to alter the image forming layer 12. For color thermal ink in layer 12, the heat is not sufficient to melt it and thus, only the image components melt and bond to the white base layer 13 from the print heat element 37 are transferred along with the white base layer 13.

Alternatively, if the image color forming layer is of the direct thermal type, the heat is not sufficient to convert the direct thermal chemistry. In this case, the transfer platen 39 only heats and transfers a round circle of both layers 12 and 13 onto the surface of the identification card 21.

FIG. 5A is a schematic representation of a preferred ribbon 50 comprising a polyester substrate 51′, a color imaging coating 52′ and a pressure sensitive adhesive 53′ which is used to attach the color printed image 52′ to the identification card. In this construction, the color forming image coating 52′ can be either a thermal transfer ink or a clear direct thermal printing chemistry. The pressure sensitive adhesive 53′ needs to be die cut in order that discrete circles can be transferred from the ribbon 50 to the identification card itself. The die cut circles 53′ can be white, colored, or security composite adhesive materials, but they will need to be separate discrete units so that only one at a time is transferred to the identification card. Also, since the ribbon 50 could be self-wound, i.e., rolled onto itself, the top surface of the roll 55 will be silicone coated in order to act as a release liner. These self-wound rolls provide an easy means of dispensing the image code material.

Referring to FIG. 5B, the die cut circles 57 of the imaging materials are transported through the printer mechanism by the web 51′. As the image circles approach the print head 58, there is no printing thereon. Under the print head, the heating elements 58 create the image as shown in 59 and upon reaching the point of application, the image has been fully printed 56.

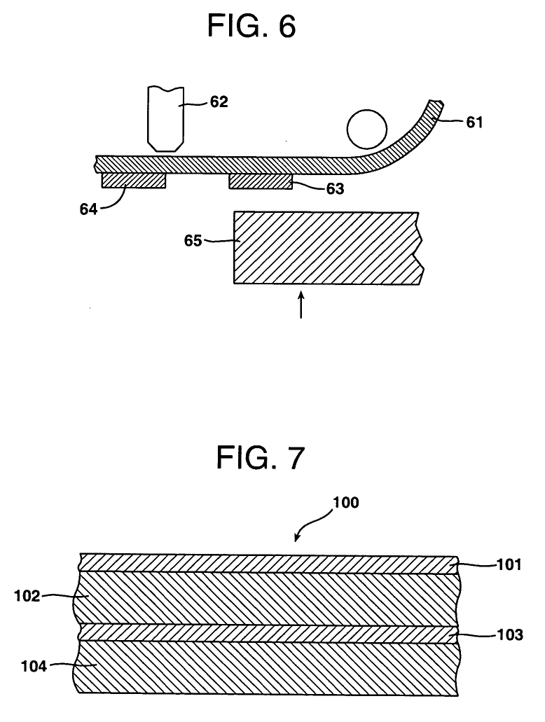

Referring to FIG. 6, at application point 63 the identification card 65 is contacted with the adhesive of the printed image code. This is accomplished by the card being inserted into a slot and pressed against the image code adhesive 63 which is on the web of the printing ribbon 61. When the card 65 is removed from the printing unit, image code 63 is attached to the identification card and the web 61 continues to the next image code material 64 to be printed.

Whereas there can be many designs for these image code printing units, they typically process the image code media in a similar manner by printing the image code, transporting the image code to an application station, and then transferring the image code to the card itself. Other designs where the image code is printed and applied at the same location are possible with more complex mechanisms. Since the image code media has no substrate but only a weak resin matrix to keep it intact and to keep the image unaltered, it would be difficult to have the image code media pass through intermediate transfer mechanisms.

As mentioned previously, this image code application process enables any identification card to be marked with image codes and does not require any special card material. The functional and marketing benefits of this are substantial. A second benefit of this image code processing system is that the image code itself posses better security than employing a labeling system with a substrate for the image code. Since single layers of the image code media cannot be removed intact, image codes can only be transferred by lifting off multiple layers of media where the increased bulk of these multiple layers produces enough strength within the material mass so support the top, most current image code. Image codes below the top layer will be impossible to separate from the mass. In addition, if one simply squeezes the mass of transfer material between their fingers, the image code image will be crushed and destroyed because there is no substrate to protect its integrity. Furthermore, it will be very difficult to strip out a single layer of media containing an image code because each layer has very little integrity.

One additional operation factor that is important is the speed with which the image code can be applied to an identification card or badge. When the image code processing system requires that an entire identification card be transported into and out of the printer mechanism this process requires 10 seconds or more. It also means that the printing mechanism is subject to contamination and damage from the identification card passing there through. By only printing and applying the image code itself, both of these problems are avoided. The image code application process described in this invention, can be speeded up to one or two seconds. It is also possible to apply the image code to any portion of the card as opposed to only being able to apply it to a specific, limited location on the card.

The printing process of this invention produces a large, dark, high resolution symbol that replaces or covers up or eliminates the previous symbol. It can print on any type of identification card or badge without damaging the card. The cycle is relatively rapid, e.g., 1-2 seconds after insertion of card, is completely automatic and permits the application of subsequent symbols or indicia for different time periods.

More specifically, the printer should have the following characteristics:
Logic Inputs to unit: Low voltage input line
Power requirements: 120/240 volts; 50/60 Hz
Installation: A freestanding unit can be placed anywhere
Panel mounted unit installed per specs
Size of unit 12″×12″×12″ max
Ribbon capacity: about 100 feet
Sensor to alert operator that ribbon needs to be changed after a predetermined amount of symbols are printed.
Cycle time for printing & applying a symbol: 1-2 seconds
Average time to insert and retrieve their Identification badge: 2-5 seconds
Maximum number of cards validated per hour: 360 people per hour
Size of symbol: 0.5″ to 0.75″
Size of white base coat for hiding previous symbol: 1/16″ all around maximum size of symbol
Color of symbol printing: Black
Ribbon construction: Two layers coated on 0.1-0.5 mil polyester ribbon:
Symbol forming middle layer: either direct thermal chemistry or thermal transfer ink; white base layer is heat activated adhesive which, when transferred to the plastic card, carries the colored image printing from the middle layer with it.

Referring to FIG. 7, which is a cross section of a preferred heat transfer ribbon used in the process of this invention, the ribbon 100 comprises a film carrier material 102 which is a polyester film of about 0.25 to 0.5 mil thickness. On top of this film carrier material 102 is a thin low friction slip layer 101, which permits the ribbon 100 to easily slide over the print head. The ribbon 100 further includes a colored printing layer 103 and a white opaque layer 104 for overlaying and hiding any images or colors that were previously on the identification badge or card. The white opaque layer 104 on the lower side of the ribbon 100 is transferred and pressed onto a substrate, for example a plastic identification card or badge. The white opaque layer 104 adheres by pressure and heat means to the substrate. The white opaque layer 104 carries with it the black ink image 103 as it is stripped away from the film carrier 102. Thus, the white layer 104 and ink layer 103 are stripped from the film carrier material 102 as a combined unit as the ribbon is transported through the printer. The image or code was created in the ink layer 103 upstream from its transfer in the transport path of the ribbon 100 and positioned under the transfer solenoid platen by any of a number of types of sensing devices.

The materials used in the ribbons are known in the art. The materials commonly used are polymers, waxes, additives, tackifiers, fillers and pigments. Other layers could be incorporated into the ribbon such as release layers that allow easy release of each layer from the ribbon. There can be a release layer between the black ink layer 103 and the white opaque layer 104, or there can be a release layer between the black ink layer 103 and the ribbon substrate 102. These release layers can be composed of low melting point polymers, waxes, silicone-based resins, Teflon type materials, etc., that are well known in the art.

A preferred embodiment of a two layer thermal transfer ribbon is similar to that of a conventional single ink layer thermal transfer ribbon. In this embodiment, the ribbon comprises a 0.25 mil polyester ribbon film (Toray Plastics America, Inc; Toray Industries, Inc.) that contains a slip layer coating 101 on one side. On the opposite side of the ribbon film is a coated (2 lbs/ream) black thermal ink layer 103, and the second layer is a white opaque (hiding) layer 104 (5 lbs/ream). The white opaque layer 104 and the black ink layer 103 transfer to the plastic card substrate by heat and pressure from the applicator solenoid and are released from the film substrate 102 after the solenoid platen lifts. The black thermal ink layer 103 and a possible release layer (0.1 lbs/ream), is bonded to the white opaque layer 104 by the linear pattern heating performed by the print head heating elements prior to the combination being transferred by the solenoid platen to the identification plastic card substrate. Release layers of this type are well known in the art.

The following is a description of the preferred elements of a preferred ribbon:

| Layer | % by weight | Component Name |
|---|---|---|
| Black Ink | 5 | Daran SI. 143 (PVC, Tg-15 C.) |
| | 38 | Vycar 352 (vinyl emulsion, Tg = −62 C.) |
| | 6 | Hycar 1561 (acrylonitrile, Tg = −19 C.) |
| | 25 | Tint Ayd NV7345 (black pigment dispersion) |
| | 26 | Vycar 151 (vinyl emulsion Tg = 85 C.) |
| Release Layer | 95 | Teflon PTFE-35 |
| | 5 | Vancryl (acrylic Emulsion Tg = 5 C.) |
| White Opaque Layer | 60 | Tint Ayd NV7003 TiO2 dispersion |
| | 30 | Hycar 26288 (Acrylic emulsion Tg = 25 C.) |
| | 10 | Water |

Vycar & Hycar trademarks of Noveon Inc
Daran trademark of W.R. Grace & Co
Tint Ayd trademark of Elementis Specialties Inc
Teflon Trademark of E.I. du pont de Nemours & Co
Vancryl trademark of Air Products & Chemicals Inc

Some of the advantages of this invention are:

1) the transferred image code can be applied to any plastic identification card no matter what the access control or photo imaging process is used.

2) the validating image code unit has no physical limitations and thus, can accept any standard identification card.

3) A new image code has a white opaque base coating so that it can be applied each day over the previous days image code. The white base coating hides the previous days image-code.

4) The image code is non-transferable since it has no substrate and has an internal structure which is a weakly cohesive resin.

5) The image code can employ a holographic base coating in place of the white base coating so that the background offers visual security and visible authenticity.

6) The image code is applied to an identification card or item surface in 1-3 seconds, much faster than the time it takes to transport an entire identification card in and out of a printing unit

Thus in summary, this invention provides a clearly visible printed image, text or symbol, on an employee identification cards (badges) for daily coding of each persons badge. The printer creates and applies, automatically, the image onto any type of identification card on a daily basis, receiving its data and commands from a control computer, which may or may not be, associated with any of the facilities computer systems. Within a building or controlled access facility, this system provides a date and/or other visual image displayed on each person's identification badge to show that each person's identification badge has been checked for authenticity and validity. This system can be used with any temporary or permanent Identification badge system, and it can be used in any facility or in any controlled access area.

While various changes may be made in the detailed construction and processes of this invention, it will be understood that such changes will be within the spirit and scope of the present invention. Having thus described the invention in detail, it is to be understood that the foregoing description is not intended to limit the spirit and scope thereof. What is desired to be protected by Letters Patent is set forth in the appended claims.

1. A process for validating an identification badge for a plurality of predetermined periods of time, comprising:
generating an initial image for an initial predetermined period of time;
transmitting the initial image to a heat transfer printing device;
heat transfer printing the initial image on the identification badge to thereby validate the badge for the initial predetermined period of time;
generating a subsequent image for a subsequent predetermined period of time;
transmitting the subsequent image to the heat transfer printing device;
heat transfer printing the subsequent image on the identification badge to overlay the initial image to thereby conceal such initial image and to thereby validate the badge for the subsequent predetermined period of time.

2. The process of claim 1, wherein the step of generating the initial image or subsequent image is done randomly.

3. A process for validating an identification badge for a plurality of predetermined periods of time, comprising:
generating an initial image for an initial predetermined period of time;
transmitting the initial image to a heat transfer printing device;
heat transfer printing an initial opaque transfer layer having the initial image thereon onto the identification badge to thereby validate the badge for the initial predetermined period of time;
generating a subsequent image for a subsequent predetermined period of time;
transmitting the subsequent image to the heat transfer printing device;
heat transfer printing a subsequent opaque transfer layer having the subsequent image thereon onto the identification badge to overlay the initial image to thereby conceal such initial image and to thereby validate the badge for the subsequent predetermined period of time.

4. The process of claim 3, wherein the step of generating the initial image or subsequent image is done randomly.

5. The process of claim 3, wherein the opaque transfer layer includes a holographic image.

6. The process of claim 3, wherein the opaque transfer layer includes reflective flakes.

7. The process of claim 3, wherein the opaque transfer layer includes an initial or a subsequent image layer bonded to an opaque base layer.

8. The process of claim 3, wherein the opaque transfer layer includes an ink initial or a subsequent image bonded to an opaque base layer.

9. The process of claim 3, wherein the opaque transfer layer includes an ink initial or a subsequent image melt bonded to an opaque base layer.

10. The process of claim 7, wherein the opaque base layer is white.

11. The process of claim 2, wherein the opaque transfer layer is tamper resistant.

12. A process for validating an identification badge for a plurality of predetermined periods of time, comprising:
generating an initial image for an initial predetermined period of time;
transmitting the initial image to a printing device;
printing onto an initial opaque transfer layer an initial image,
bonding the initial opaque transfer layer onto the identification badge to thereby validate the badge for the initial predetermined period of time;
generating a subsequent image for a subsequent predetermined period of time;
transmitting the subsequent image to the printing device;
printing onto a subsequent opaque transfer layer a subsequent image,
bonding the subsequent opaque transfer layer onto the identification badge to overlay the initial image to thereby conceal such initial image and to thereby validate the badge for the subsequent predetermined period of time.

13. The process of claim 13, wherein the step of generating the initial image or subsequent image is done randomly.

14. A process for validating an identification badge for a plurality of predetermined periods of time, comprising:
generating an initial image for an initial predetermined period of time;
transmitting the initial image to a heat transfer printing device;
heat transfer printing onto an initial opaque transfer layer an initial image,
heat bonding the initial opaque transfer layer onto the identification badge to thereby validate the badge for the initial predetermined period of time;
generating a subsequent image for a subsequent predetermined period of time;
transmitting the subsequent image to the heat transfer printing device;
heat transfer printing onto a subsequent opaque transfer layer a subsequent image,
heat bonding the subsequent opaque transfer layer onto the identification badge to overlay the initial image to thereby conceal such initial image and to thereby validate the badge for the subsequent predetermined period of time.

15. The process of claim 15, wherein the step of generating the initial image or subsequent image is done randomly.

16. A continuous heat transfer ribbon comprising:
a continuous carrier film having an upper surface and a lower surface;
a colored printing layer overlaying the lower surface of the carrier film; and
an opaque layer overlaying the printing layer.

17. A continuous heat transfer ribbon comprising:
a continuous carrier film having an upper surface and a lower surface;
a low friction slip layer overlaying the upper surface of the carrier film,
a colored printing layer overlaying the lower surface of the carrier film; and
an opaque layer overlaying the printing layer.

18. The heat transfer ribbon of claim 12, wherein the film carrier material is a polyester film.

19. The heat transfer ribbon of claim 13, wherein the film carrier material is a polyester film.

20. A process for validating an identification badge for a plurality of predetermined periods of time, comprising:
generating an initial image for an initial predetermined period of time;
transmitting the initial image to a printing device;
printing the initial image on the identification badge to thereby validate the badge for the initial predetermined period of time;
generating a subsequent image for a subsequent predetermined period of time;
transmitting the subsequent image to the printing device;
printing the subsequent image on the identification badge to overlay the initial image to thereby conceal such initial image and to thereby validate the badge for the subsequent predetermined period of time.

21. The process of claim 20, wherein the step of generating the initial image or subsequent image is done randomly.

22. A process for validating an identification badge for a plurality of predetermined periods of time, comprising:
generating an initial image for an initial predetermined period of time;
transmitting the initial image to a printing device;
printing an initial opaque transfer layer having the initial image thereon onto the identification badge to thereby validate the badge for the initial predetermined period of time;
generating a subsequent image for a subsequent predetermined period of time;
transmitting the subsequent image to the printing device;
printing a subsequent opaque transfer layer having the subsequent image thereon onto the identification badge to overlay the initial image to thereby conceal such initial image and to thereby validate the badge for the subsequent predetermined period of time.

23. The process of claim 22, wherein the step of generating the initial image or subsequent image is done randomly.

24. The process of claim 22, wherein the opaque transfer layer includes a holographic image.

25. The process of claim 22, wherein the opaque transfer layer includes reflective flakes.

26. The process of claim 22, wherein the opaque transfer layer includes an initial or a subsequent image layer bonded to an opaque base layer.

27. The process of claim 22, wherein the opaque transfer layer includes an ink initial or a subsequent image bonded to an opaque base layer.

28. The process of claim 22, wherein the opaque transfer layer includes an ink initial or a subsequent image melt bonded to an opaque base layer.

29. The process of claim 28, wherein the opaque base layer is white.

30. The process of claim 22, wherein the opaque transfer layer is tamper resistant.
